(19) United States
(12) Patent Application Publication
(10) Pub. No.: US 2015/0291071 A1
(43) Pub. Date: Oct. 15, 2015

(54) RETRACTABLE VEHICLE SEAT COVER DEVICE

(71) Applicant: Kevin Thompson, Rock Hill, SC (US)

(72) Inventor: Kevin Thompson, Rock Hill, SC (US)

(21) Appl. No.: 14/248,432

(22) Filed: Apr. 9, 2014

(51) Int. Cl. B60N 2/60

(52) U.S. Cl. CPC B60N 2/6036

(57) ABSTRACT

A retractable vehicle seat cover device for covers a vehicle seat preventing debris from getting onto or into the vehicle seat. The device includes a housing comprising a top wall, a bottom wall, and a perimeter wall extending between and around the top wall and the bottom wall defining an interior space. The housing is configured for coupling to a vehicle seat. A slot extends through the housing into the interior space. A roller mechanism is coupled to the housing and positioned in the interior space. A cover has a first end coupled to the roller mechanism wherein the cover is selectively extendable from and retractable onto the roller mechanism. The cover is extendable through the slot wherein the cover is configured for covering the vehicle seat. A retainer is coupled to the cover and configured for holding the cover in a position covering the vehicle seat.

### BACKGROUND OF THE DISCLOSURE

### Field of the Disclosure

The disclosure relates to seat cover devices and more particularly pertains to a new seat cover device for selectively covering a vehicle seat to prevent debris from getting onto or into the vehicle seat.

### SUMMARY OF THE DISCLOSURE

An embodiment of the disclosure meets the needs presented above by generally comprising a housing comprising a top wall, a bottom wall, and a perimeter wall extending between and around the top wall and the bottom wall defining an interior space. The housing is configured for coupling to a vehicle seat. A slot extends through the housing into the interior space. A roller mechanism is coupled to the housing and positioned in the interior space. A cover has a first end coupled to the roller mechanism wherein the cover is selectively extendable from and retractable onto the roller mechanism. The cover is extendable through the slot wherein the cover is configured for covering the vehicle seat. A retainer is coupled to the cover and configured for holding the cover in a position covering the vehicle seat.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a retractable vehicle seat cover device according to an embodiment of the disclosure.

FIG. 2 is a top front side perspective view of an embodiment of the disclosure in a semi-retracted position.

FIG. 3 is a side view of an embodiment of the disclosure.

FIG. 4 is a top front side perspective view of an embodiment of the disclosure.

FIG. 5 is a side view of an embodiment of the disclosure in use.

FIG. 6 is a side view of an embodiment of the disclosure in use.

FIG. 7 is a top front side perspective view of an embodiment of the disclousre.

### DESCRIPTION OF THE PREFERRED EMBODIMENT

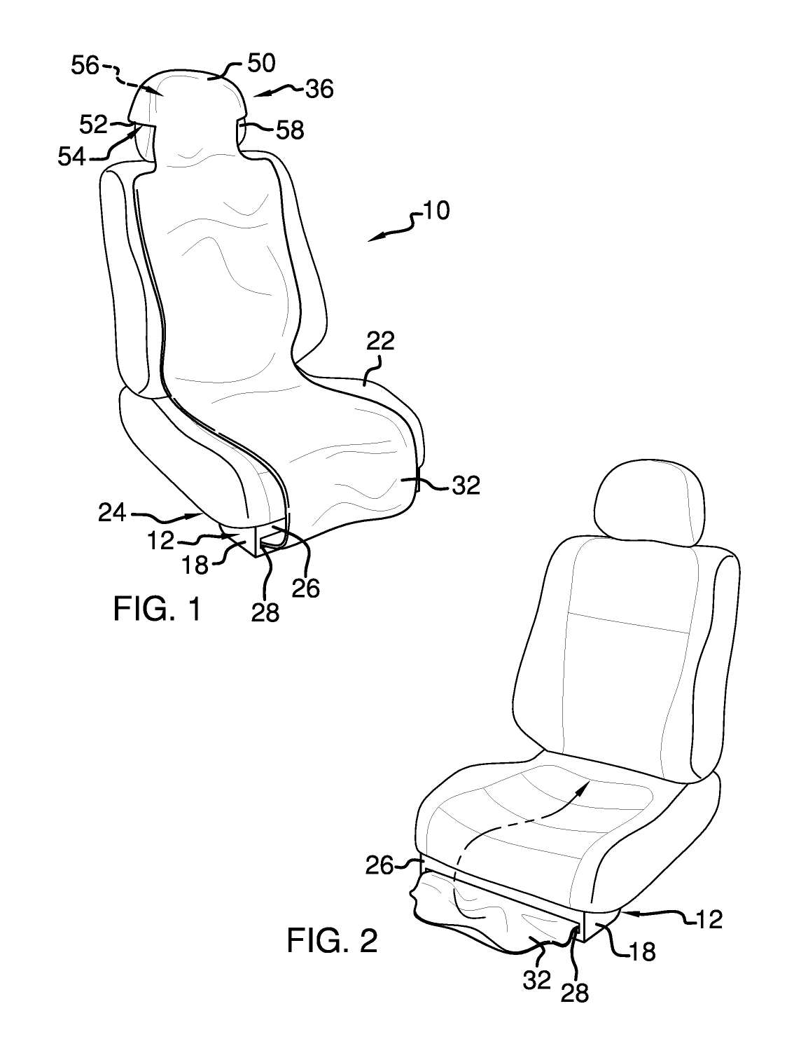

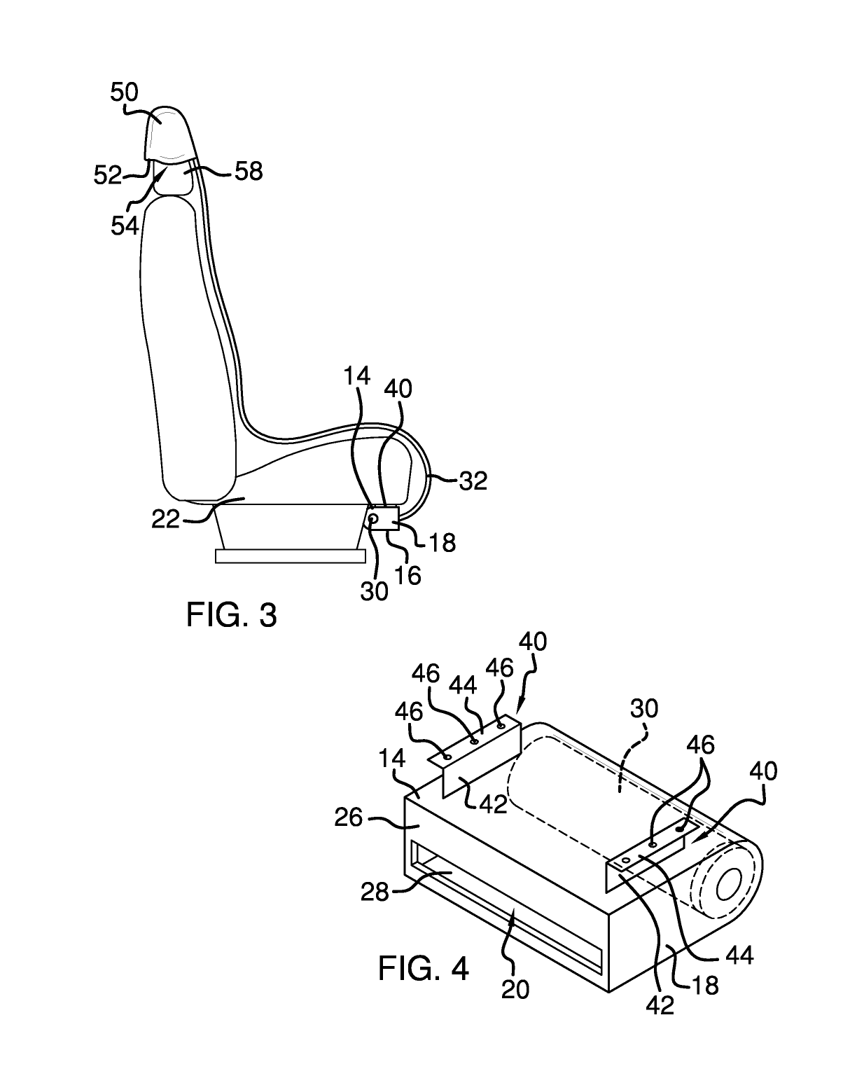

With reference now to the drawings, and in particular to FIGS. 1 through 7 thereof, a new seat cover device embodying the principles and concepts of an embodiment of the disclosure and generally designated by the reference numeral 10 will be described.

As best illustrated in FIGS. 1 through 7, the retractable vehicle seat cover device 10 generally comprises a housing 12 comprising a top wall 14, a bottom wall 16, and a perimeter wall 18 extending between and around the top wall 14 and the bottom wall 16 defining an interior space 20. The housing 12 is configured for coupling to a vehicle seat 22. More particularly, the housing 12 is designed to be coupled to an underside 24 of the vehicle seat 22 with a front face 26 of the housing 12 facing forwardly relative to the vehicle seat 22. A mounting bracket 40 may be coupled to and extend from the top wall 14 of the housing 12 supporting the housing 12 in spaced relationship under the vehicle seat 22 to facilitate access to the housing 12. The mounting bracket 40 may have an extension section 42 and a connection section 44, each being planar and transversely oriented defining a substantially L-shaped member. Each of a plurality of apertures 46 extends through the connection section 44 to allow connection to the vehicle seat 22 using a conventional fastener such as a bolt, screw, or the like. The mounting bracket 40 may be one of a pair of similarly constructed mounting brackets 40. The mounting brackets 40 may be positioned in spaced parallel relationship to each other and transversely oriented relative to the forward face 26 of the housing 12.

A slot 28 extends through the front face 26 of the housing 12 into the interior space 20. A roller mechanism 30, similar in type and construction to what is found in a conventional retractable window blind, is coupled to the housing 12 and positioned in the interior space 20. A cover 32 has a first end 34 coupled to the roller mechanism 30 such that the cover 32 is selectively extendable from and retractable onto the roller mechanism 30. The cover 32 is extendable through the slot 28 wherein the cover 32 is configured for extending over and covering a forward side of the vehicle seat 22.

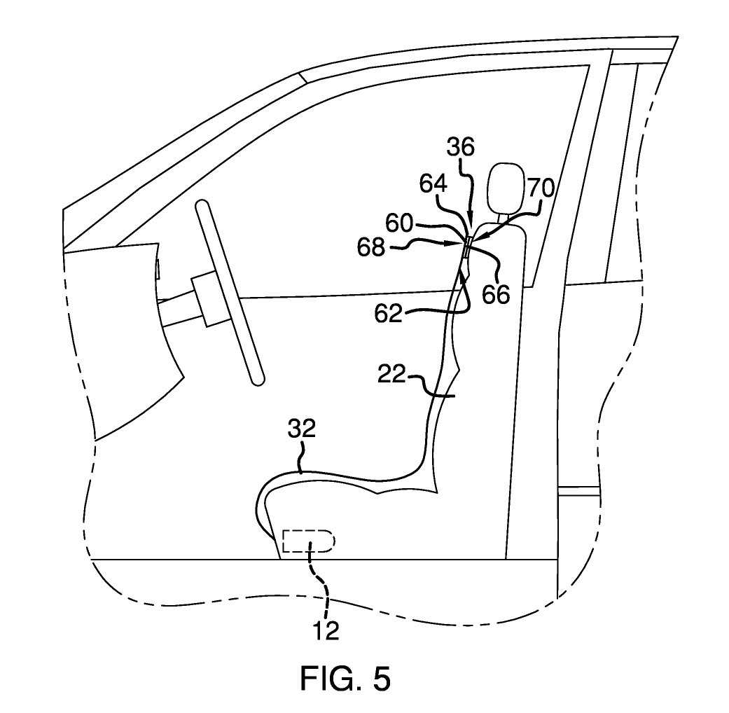

A retainer 36 is coupled to the cover 32. The retainer 36 is configured for holding the cover 32 in a position covering the vehicle seat 22. The retainer 36 may take alternative forms. The retainer 36 may be a hood 50 having a perimeter edge 52 defining an opening 54 into a cavity 56 configured for receiving a top 58 of the vehicle seat 22. The top of the vehicle seat 22 may comprise a headrest or just a top face of a backrest section of the vehicle seat 22 positionable within the cavity 56 wherein the cover 32 is prevented from retracting into the housing 12. As shown in FIG. 5, the retainer 36 may alternatively comprise a first portion 60 of hook and loop fastener coupled to a face 62 of the cover 32 contacting the vehicle seat 22 as the cover 32 extends over the front of the vehicle seat 22. The first portion 60 of hook and loop fastener is positioned proximate a distal end 64 of the cover 32 relative to the roller mechanism 30. The first portion 60 of hook and loop fastener may more specifically comprise hook type fastener 68 which may be sufficient to engage the vehicle seat 22 directly. However, the retainer 36 may further comprise a second portion 66 of hook and loop fastener complementary to the first portion 60 of hook and loop fastener. The second portion 66 of hook and loop fastener is configured for coupling to the vehicle seat 22 on, adjacent to, or sufficiently proximate the top face of the vehicle seat 22 to allow substantially full coverage of the front of the vehicle seat 22 when the first portion 60 engages the second portion 66 of hook and loop fastener. The second portion 66 of hook and loop fastener is a loop portion 70, particularly when positioned on a surface of the vehicle seat 22 that may contact a person sitting on the vehicle seat 22 without the cover 32 being extended. Thus, the second portion 66 of hook and loop fastener will not snag on clothing of the person or abrade bare skin while the person sits in the vehicle seat 22.

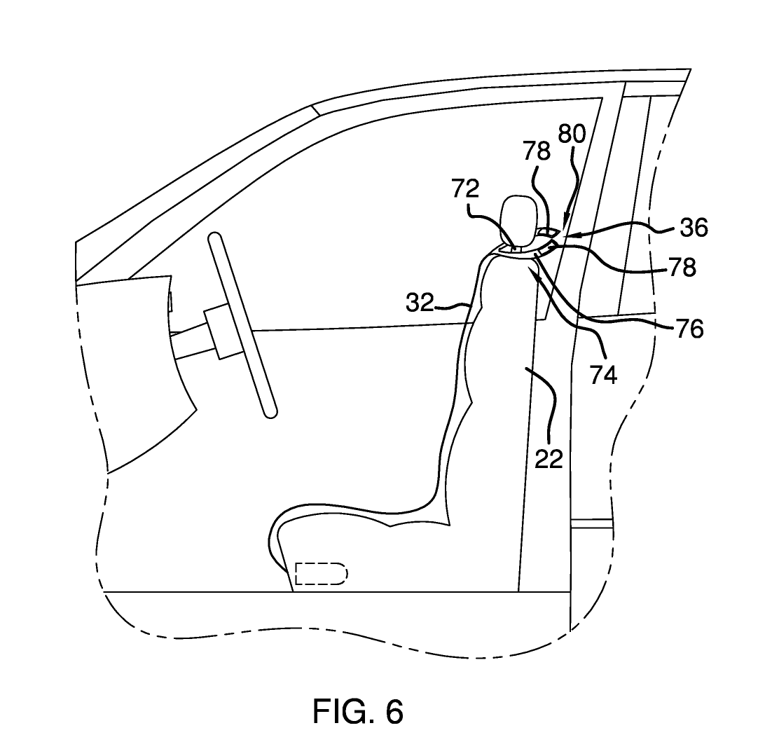

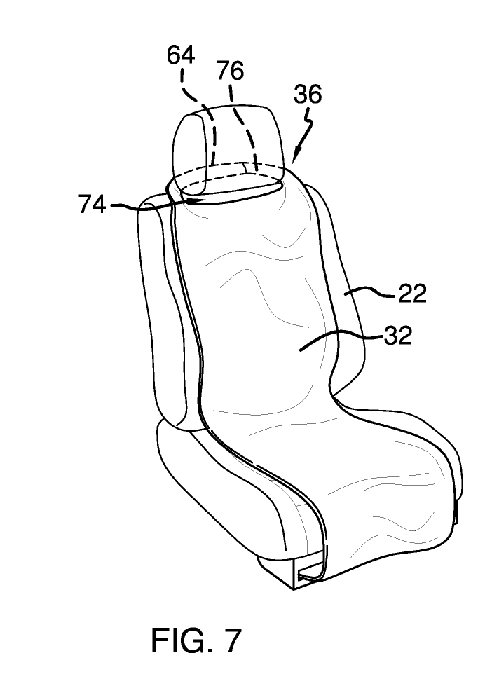

As shown in FIGS. 6 and 7, the retainer 36 may be formed by providing a cutout 72 proximate the distal end 64 of the cover 32 forming a loop 74 positionable over the headrest such that the cover 32 is held in an extended position over the vehicle seat 22. A portion of the cover 32 between the cutout 72 and the distal end 64 of the cover 32 may define a strap 76. The strap 76 may have a break 80 therein and include a fastener 78 such as hook and loop fastener, snaps, or the like to secure the strap 76 around the headrest.

In use, the cover 32 is selectively extended when desired. While shown being coupled to the vehicle seat 22, the cover may equally be extended over and cover a person seated in the vehicle seat 22 to prevent spillage on the person while eating in the vehicle. As shown, the cover 32 is secured to the vehicle seat 22 using the retainer 36. This may be done when a vehicle is moved by a mechanic potentially wearing a soiled coverall, to catch crumbs or spills when a person eats while sitting on the vehicle seat 22, or to prevent wear on the vehicle seat 22 by use every time a person sits on the vehicle seat 22. The retraction of the cover 32 quickly facilitates display of the original appearance of the vehicle seat in an uncovered condition.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A retractable vehicle seat cover device comprising:
a housing comprising a top wall, a bottom wall, and a perimeter wall extending between and around said top wall and said bottom wall defining an interior space, said housing being configured for coupling to a vehicle seat;
a slot extending through said housing into said interior space;
a roller mechanism coupled to said housing and positioned in said interior space;
a cover having a first end coupled to said roller mechanism wherein said cover is selectively extendable from and retractable onto said roller mechanism, said cover being extendable through said slot wherein said cover is configured for covering said vehicle seat; and
a retainer coupled to said cover, said retainer being configured for holding said cover in a position covering the vehicle seat.

2. The device of claim 1, further comprising said retainer being a hood having a perimeter edge defining an opening into a cavity configured for receiving a top of the vehicle seat such that said cover extends over a front side of the vehicle seat.

3. The device of claim 1, further comprising said retainer being a portion of hook and loop fastener coupled to a face of said cover proximate a distal end of said cover relative to said roller mechanism.

4. The device of claim 3, further comprising said retainer comprising a second portion of hook and loop fastener, said second portion of hook and loop fastener being complementary to said first portion of hook and loop fastener, said second portion of hook and loop fastener being configured for coupling to the vehicle seat.

5. The device of claim 4, further comprising said second portion of hook and loop fastener being a loop portion.

6. The device of claim 1, further comprising a mounting bracket coupled to and extending from said top wall of said housing.

7. The device of claim 6, further comprising:
said mounting bracket having an extension section and a connection section; and
a plurality of apertures extending through said connection section.

8. The device of claim 6, further comprising said mounting bracket being one of a pair of said mounting brackets.

9. A retractable vehicle seat cover device comprising:
a housing comprising a top wall, a bottom wall, and a perimeter wall extending between and around said top wall and said bottom wall defining an interior space, said housing being configured for coupling to a vehicle seat;
a slot extending through said housing into said interior space;
a roller mechanism coupled to said housing and positioned in said interior space;
a cover having a first end coupled to said roller mechanism wherein said cover is selectively extendable from and retractable onto said roller mechanism, said cover being extendable through said slot wherein said cover is configured for covering said vehicle seat;
a retainer coupled to said cover, said retainer being configured for holding said cover in a position covering the vehicle seat; and
a mounting bracket coupled to and extending from said top wall of said housing, said mounting bracket having an extension section and a connection section, a plurality of apertures extending through said connection section, said mounting bracket being one of a pair of said mounting brackets.

10. The device of claim 9, further comprising said retainer being a hood having a perimeter edge defining an opening into a cavity configured for receiving a top of the vehicle seat such that said cover extends over a front side of the vehicle seat.

11. The device of claim 9, further comprising said retainer comprising a first portion of hook and loop fastener coupled to a face of said cover proximate a distal end of said cover relative to said roller mechanism, said retainer comprising a second portion of hook and loop fastener, said second portion of hook and loop fastener being complementary to said first portion of hook and loop fastener, said second portion of hook and loop fastener being configured for coupling to the vehicle seat, said second portion of hook and loop fastener being a loop portion.
